(19) United States
(12) Patent Application Publication
(10) Pub. No.: US 2013/0037136 A1
(43) Pub. Date: Feb. 14, 2013

(54) FLUID FLOW CONTROL DEVICE

(71) Applicant: Christopher Iveson, Sheffield (GB)

(72) Inventor: Christopher Iveson, Sheffield (GB)

(21) Appl. No.: 13/570,034

(22) Filed: Aug. 8, 2012

(30) Foreign Application Priority Data
Aug. 8, 2011 (GB) 1113644.7

(51) Int. Cl. F16K 15/00

(52) U.S. Cl. 137/528

(57) ABSTRACT

A fluid control device includes a housing providing a fluid inlet and fluid outlet and a passage extending therebetween. The passage has a longitudinally extending tapered portion which narrows in the direction towards the inlet, and a fluid flow control member located in the passage and having a tapered end corresponding to the tapered portion of the passage. The fluid flow control member is movable longitudinally within the passage between a first position, in which the tapered end of the member engages the tapered portion of the passage and fluid flow along the passage towards the inlet is prevented, and a second position in which fluid flow along the passage is possible.

### BACKGROUND OF THE INVENTION

1. Field of the Invention

The present invention relates to water management systems, and, in particular, one way valves that are free of any restriction when fluid is flowing in one direction, yet automatically close when fluid flows in the opposite direction. The fluid may be, typically, water or oil.

2. Description of the Prior Art

A seal support system comprises a vessel/tank, which generally contains a volume of fluid. The vessel is piped to a sealing device on a pump, mixer or piece of rotating equipment. Generally there is a return pipe that is connected back to the vessel, which closes the “loop.” The fluid inside the vessel is referred to in the industry as barrier/buffer fluid.

A mechanical seal, which is supported by the seal support system, generally comprises a rotating member attached to a pump shaft, and a stationary member attached to the pump housing. The rotating member is in direct contact with the stationary member, which provides the seal. A basic operating principle of mechanical seals is that they require a “fluid film” that provides a lubricant between the stationary and rotating members. The barrier/buffer fluid inside said seal support system generally provides the fluid film, via the seal's barrier/buffer fluid inlet pipe, which extends from the vessel/tank to the mechanical seal. There is also present a barrier/buffer fluid outlet pipe, which extends from the mechanical seal back to the vessel/tank, which closes the barrier/buffer fluid loop.

Commonly used on said seal support systems are other items of equipment that perform various duties. Some examples of these are pressure regulators and extra pieces of cooling equipment that help cool the barrier/buffer fluid.

A major purpose of the barrier/buffer fluid is to provide cooling to the mechanical seal, and, as such, it needs to circulate around the barrier/buffer fluid loop to disperse the heat effectively. A common method used to achieve this is thermosyphoning in which, as the water picks up the heat generated by the mechanical seal faces, it rises through the barrier/buffer fluid outlet pipe and enters the vessel/tank. It then cools and falls downwards back through the barrier/buffer fluid inlet towards the mechanical seal. One major problem with thermosyphoning is that it generates very little flow of the barrier/buffer fluid and as such, any restriction to this barrier/buffer fluid loop can prevent flow all together. If flow is prevented from occurring, the heat generated by the mechanical seal faces cannot be dispersed effectively and the mechanical seal may overheat, causing costly failures. Therefore it is imperative that there is no restriction in barrier/buffer fluid loop.

When the fluid is circulating the desired way around the barrier/buffer fluid loop, this shall be known as positive flow, and when the flow reverses, it will be referred to as negative flow.

In some applications, it is desirable to install a negative flow prevention valve, the purpose of which is to allow fluid to circulate only one way through the barrier/buffer fluid loop. If there is a tendency for negative flow to occur, the valve will prevent it.

On the marketplace there are various different versions of these valves, commonly known in the industry as check valves. However they all pose a restriction, which prevents thermosyphoning from taking place. As such they are unsuitable for use in thermosyphoning applications. The present invention addresses this problem and provides a check valve, which when water flows in the correct direction, the fluid flow control device poses no restriction to water flow.

### SUMMARY OF THE INVENTION

According to the present invention, there is provided a fluid control device comprising a housing providing a fluid inlet and fluid outlet and a passage extending therebetween. The passage has a longitudinally extending tapered portion which narrows in the direction towards the inlet, and a fluid flow control member located in the passage and having a tapered end corresponding to the tapered portion of the passage. The fluid flow control member is movable longitudinally within the passage between a first position, in which the tapered end of the member engages the tapered portion of the passage and fluid flow along the passage towards the inlet is prevented, and a second position in which fluid flow along the passage is possible. The fluid flow control member includes a laterally extending surface which faces longitudinally towards the outlet, so that, if the fluid flow is in the direction of the inlet, the fluid will impinge upon the laterally extending surface and cause the fluid flow control member to be pushed into the first position.

Accordingly the present invention provides a non-restrictive negative flow prevention valve. When a minimal positive flow is generated (usually by thermosyphoning alone) the valve allows the fluid to pass through. However when there starts to be a negative flow acting through the valve, it automatically closes, thus preventing the negative flow.

Preferably, the longitudinally extending surface is located within the tapered end portion of said member. More preferably, the longitudinally extending surface is a substantially concave surface.

Preferably, the tapered end is substantially conical.

Preferably, the member is provided with a plurality of orifices or slots longitudinally spaced from said tapered end portion. More preferably, the combined area of the orifices or slots is equal to, or greater than, the cross-sectional area of both the said inlet and said outlet.

Preferably, the external and internal surfaces of said tapered end of said member are substantially parallel.

Preferably, a circlip is mounted in said passage, said circlip preventing movement of the member beyond said second position in a direction away from said first position.

Preferably, the inlet and the outlet are provided with means for connecting the device to other devices such as pipework. More preferably, the connection means are screw threads.

Preferably, the housing is adapted for engagement by a suitable support tool or element. More preferably, the housing is so adapted by being provided with an external hexagonal portion surrounding said passage.

Other objects and features of the present invention will become apparent when considered in combination with the accompanying drawing figures, which illustrate certain preferred embodiments of the present invention. It should, however, be noted that the accompanying drawing figures are intended to illustrate only select preferred embodiments of the claimed invention and are not intended as a means for defining the limits and scope of the invention.

### BRIEF DESCRIPTION OF THE DRAWING FIGURES

In the drawing, wherein similar reference numerals and symbols denote similar features throughout the several views:

FIG. 1 is a perspective view of a non-restrictive negative flow prevention valve of the invention; which includes methods for attaching said valve via a screw thread at either side of the valve;

FIG. 2 is an exploded view of the valve of FIG. 1; and,

FIG. 3 is a cutaway view of the valve of FIG. 1.

### DETAILED DESCRIPTION OF THE DRAWING FIGURES AND PREFERRED EMBODIMENTS

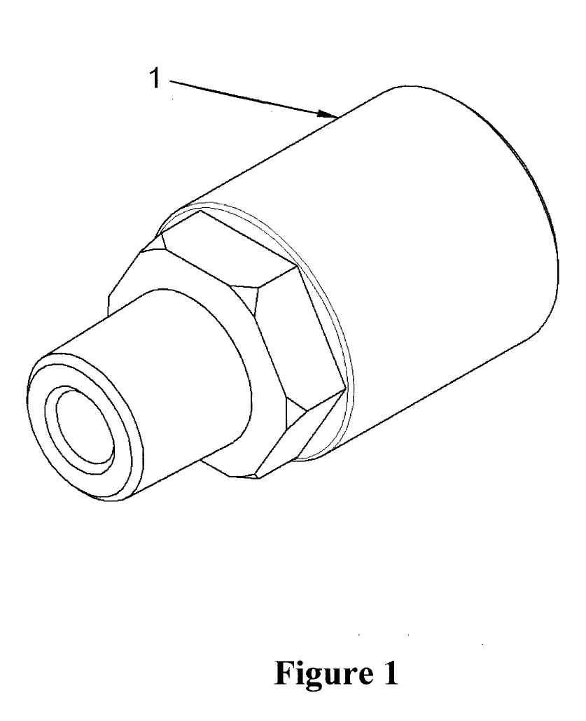

FIG. 1 illustrates a non-restrictive negative flow prevention valve 1.

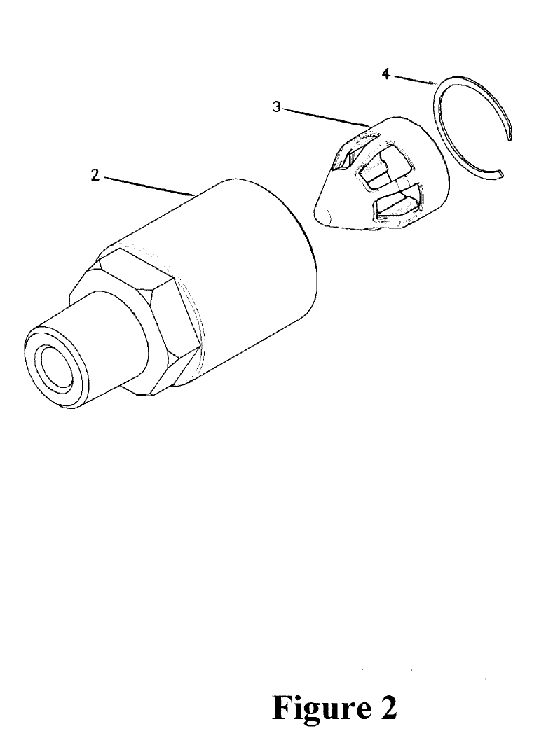

Referring to FIGS. 1 and 2 of the accompanying drawings, a non-restrictive negative flow prevention valve 1, includes a valve body 2, which houses a conical member 3, as well as a valve circlip 4, the purpose of which is to keep the conical member 3 housed inside said valve body 2.

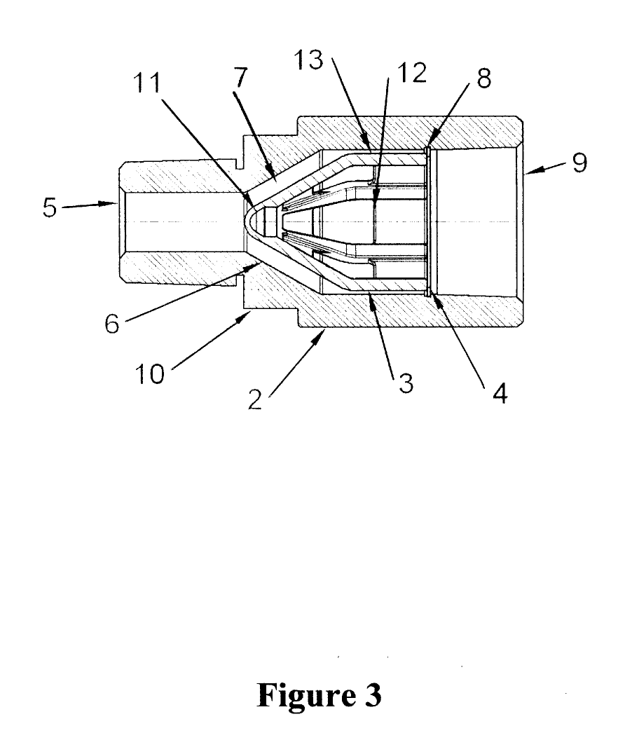

FIG. 3 is a cross-sectional view of said non-restrictive negative flow prevention valve 1. The valve body 2 comprises a valve body fluid inlet 5, a valve body angled wall portion 6, a valve body chamber 7, a valve body circlip groove 8, a fluid outlet 9, and another hexagonal portion 10 forming part of the valve body 2. The conical member 3, comprises a conical member fluid chamber 11, number of conical member fluid orifices/slots 12 and a parallel wall 13 which extends substantially parallel to the wall of valve body 2.

During normal operation, the fluid enters the valve body fluid inlet 5, and passes through chamber 7, through the orifices/slots 12 and out of the fluid outlet 9.

Preferably, the flow, which is normally generated by thermosyphoning alone, and as such, is minimal, is enough to push the conical member 3 back against valve circlip 4, leaving a gap around the outside of said valve body chamber 7, for the fluid to pass through. This action is referred to as positive flow.

When fluid enters through the valve body fluid outlet 9, and attempts to pass through chamber 7 and out of said valve body fluid inlet 5, this action is referred to as negative flow.

When there is negative flow present, the conical member fluid chamber 11, which has a concave geometry in order to optimize the efficiency of said conical member, intercepts said liquid flow, and the conical member 3 travels towards said valve body fluid inlet 5, whereby the walls of conical member 3 align with the valve body angled walls 6, thus causing a seal and preventing the negative flow.

When the flow returns to positive flow, i.e. it enters through said valve body fluid inlet 5 and out of said valve body fluid outlet 9, the conical member 3 travels back against said valve circlip 4, thus allowing flow through said conical member fluid orifices/slots 12.

The said valve body 2 has standard connections to fluid inlet 5 and fluid outlet 9. An example of a typical connection could be a male or female screw thread; however any suitable connection would be applicable.

The valve body chamber has suitable geometry for attaching a tool. In the present embodiment, this takes the form of the valve body hex geometry 10, which is suitable for a spanner; however other suitable geometries for other tools may also be applicable in other embodiments.

The minimum combined cross-section of said conical member fluid orifices/slots 12 is equal to, or greater than, the cross-sectional area of any other area within the non-restrictive negative flow prevention valve 1. This ensures that said valve does not restrict the flow when traveling in through said valve body fluid inlet 5.

The parallel wall 13 of said conical member 3 prevents the conical member 3 from twisting inside said valve body 2. The parallel wall 13 also acts to centralize said conical member 3 inside said valve body chamber 7.

While only several embodiments of the present invention have been shown and described, it will be obvious to those skilled in the art that many modifications may be made to the present invention without departing from the spirit and scope thereof.

What is claimed is:

1. A fluid flow control device comprising a housing providing a fluid inlet and fluid outlet and a passage extending therebetween, said passage having a longitudinally extending tapered portion narrowing in a direction towards said fluid inlet, and a fluid flow control member located in said passage and having a tapered end corresponding to the longitudinally extending tapered portion of the passage, said fluid flow control member being movable longitudinally within said passage between a first position, wherein a tapered end of the fluid flow control member engages the longitudinally extending tapered portion of the passage and fluid flow along the passage towards said fluid inlet is prevented, and a second portion, wherein fluid flow along the passage is possible, the fluid flow control member including a laterally extending surface facing longitudinally towards said fluid outlet so that, if fluid flow is in a direction towards said fluid inlet, said flowing fluid will impinge on a surface of said longitudinally extending tapered portion for causing said fluid flow control member to be pushed into said first position.

2. The fluid flow control device according to claim 1, wherein the laterally extending surface is located within the tapered end of said fluid flow control member.

3. The fluid flow control device according to claim 1, wherein the laterally extending surface is a substantially concaved surface.

4. The fluid flow control device according to claim 1, wherein the tapered end corresponding to the longitudinally extending tapered portion of the passage and the tapered end of said fluid control member are substantially conical.

5. The fluid flow control device according to claim 1, wherein said fluid flow control member is provided with a plurality of orifices or slots longitudinally spaced from said tapered end.

6. The fluid flow control device according to claim 5, wherein a combined cross-sectional area of said orifices or slots is equal to, or greater than, the cross-sectional area of either said fluid inlet or said fluid outlet.

7. The fluid flow control device according to claim 5, wherein a combined cross-sectional area of said orifices or slots is equal to or greater than the cross-sectional area of both said fluid inlet and said fluid outlet.

8. The fluid flow control device according to claim 1, wherein external and internal surfaces of said tapered end of said fluid flow control member are substantially parallel.

9. The fluid flow control device according to claim 1, wherein a circlip is mounted in said passage, said circlip preventing movement of the fluid flow control member beyond said second position in the direction away from said first position.

10. The fluid flow control device according to claim 1, wherein said fluid inlet and said fluid outlet are provided with means for connecting said fluid flow control device to an additional device.

11. The fluid flow control device according to claim 10, wherein said additional device is pipework.

12. The fluid flow control device according to claim 10, wherein said means for connecting said fluid flow control device to an additional device are screw threads.

13. The fluid flow control device according to claim 1 wherein said housing has a hexagonal portion on its external surface.
